(19) United States
(12) Patent Application Publication
(10) Pub. No.: US 2008/0177760 A1
(43) Pub. Date: Jul. 24, 2008

(54) Methods and systems for contacting physicians

(76) Inventor: Edward Dennis Fein, East Brunswick, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/654,962

(22) Filed: Jan. 18, 2007

(51) Int. Cl. G06F 15/16; G06F 17/30

(52) U.S. Cl. 707/100; 709/206; 707/200; 707/E17.006; 707/E17.044

(57) ABSTRACT

A method of contacting a physician to electronically communicate with the physician includes storing electronic data identifying a plurality of physicians and/or their designees and contacting instructions associated with each identified physician, enabling a user to select one of the identified physicians to contact and in response to the user's selection, transmitting an electronic communication from the user terminal over a communication channel in accordance with the contacting instructions associated with the selected physician.

### BACKGROUND OF THE INVENTION

The present invention relates to methods and systems for contacting physicians and communicating, for example, patient-related data to them.

An attending physician is a doctor who has primary responsibility for the treatment and care of a particular patient. Attending physicians sometimes consult with other doctors and consultants to help them determine an appropriate treatment regimen for their patients. It is important, therefore, that the attending physician, and any other doctors or consultants that the attending physician might consult, receive patient-related data, such as test results, x-rays, etc. for their patients in a timely manner.

There are a variety of options available for contacting and/or transmitting information to an attending physician and/or other interested parties. Such options include, for example, home phones, office phones, secondary office phones, cell phones, secondary cell phones, personal digital assistants, SMS messaging to cell phones, electronic pagers, e-mail, push e-mail, BlackBerry® devices, pocket personal computing devices, the postal service, facsimile machines, etc. In view of the availability of so many options, physicians are faced with the difficult task of managing how best to be reached when needed by patients, other physicians, other medical personnel or personal contacts. Moreover, individuals charged with contacting the physician to send patient-related and other data often face difficult decisions about how to make that contact and send that information. Depending on what type of data is being sent, different communication options might be more appropriate than others. Accordingly determining how to contact a physician and send that physician patient-related and other data can be challenging and time-consuming.

Consider, for example, how a laboratory technician in a hospital might send a patient's test results to a responsible party (e.g., an attending physician and/or other parties that will play a role in evaluating those test results). That technician might decide to tell a floor nurse assigned to the patient that the test results are ready. The floor nurse might then review the patient's chart to identify the attending physician. The floor nurse might then find the attending physician's contact information and call a phone number for the attending physician. The floor nurse might reach an answering service and/or might be directed to call other numbers if the matter is important. The floor nurse is then faced with trying to determine the importance of the test results. To do that, the floor nurse might consult with others including, for example, the lab technician. If the test results are important enough, the floor nurse might decide to call those other numbers. Often, the floor nurse might need to call several different numbers before actually reaching the attending physician. The floor nurse also may have left one or more messages for the attending or designated covering physician at one or more places. Physicians often delegate responsibility for particular patients to other physicians during off-hours or vacations.

When the floor nurse finally speaks to the attending physician, the floor nurse and the attending physician might discuss the test results. The attending physician might instruct the nurse, for example, to e-mail the test results to the attending physician and to fax the test results to a colleague that the attending physician wants to consult regarding the test results. The floor nurse then would send the test results as instructed and would subsequently attempt to confirm that the test results had been received.

Additionally, physicians generally prefer to be contacted in different ways depending, at least, on who is trying to contact them and what type of information that person wants to send. For example, a physician might want close colleagues to be able to reach them directly for quick questions. That same physician might want routine questions routed to designated parties. As another example, if a physician is inaccessible because he or she is operating on a patient, that physician might want a physician extender or house staff member to be contacted.

Improvements in methods of contacting and/or sending information to physicians and/or their designees and systems adapted to those methods are desirable.

### SUMMARY OF THE INVENTION

In one aspect, a method is disclosed for contacting a physician to electronically communicate with the physician. The method includes storing electronic data identifying names of physicians and contacting instructions for each of the identified physicians, enabling a user to select one of the identified physicians to contact and in response to the user's selection, transmitting an electronic communication from the user terminal over a communication channel in accordance with the contacting instructions that are associated with the selected physician. The term physician herein should be construed broadly to include physicians, physician extenders and any other medical personnel authorized to direct or order treatment of a patient.

In some implementations, the method also includes enabling each identified physician to customize at least some of the individualized contacting instructions that correspond to them.

The applicability of at least one of the selected physician's instructions might depend on a condition precedent. In those instances, the method includes electronically reviewing characteristics associated with the communication to determine whether the condition precedent is satisfied. In various embodiments, electronically reviewing the characteristics associated with the communication includes electronically searching the communication for keywords that relate to the condition precedent, referencing an electronic clock/calendar to determine whether the communication is being transmitted at a time relevant to the condition precedent, and/or utilizing an electronic tracking system, such as a satellite navigation system to identify the selected physician's physical location when the communication is being transmitted. Other technology can be implemented to track the location of a physician, such as LoJack®-type systems, systems that determine location based on the access point in a wireless local area network (e.g., wi-fi) that a mobile device uses, etc.

Certain embodiments of the method include presenting a list of the identified physicians to a user at a user terminal. The list of physician names can also be accompanied by contact information associated with one or more ways of contacting each identified physician and each identified physician's contacting instructions. The list of physician names can be accompanied by each identified physician's availability for being contacted.

Some implementations of the method include prompting the user to enter a patient's name at the user terminal and referencing an electronic database to correlate the patient's name to the selected physician's name. Once a selected physician is identified, some embodiments of the method include sending an electronic communication over the communication channel to a destination that corresponds to the selected physician's contacting instructions. Typically, the electronic communication travels across a network and is received at the destination.

The electronic communication can be, for example, an e-mail, an instant message, a voice signal, a posting to an electronic bulletin board, a personal digital assistant message, an SMS messages to a cell phone, an electronic page, a push e-mail, a signal to a pocket personal computing device or a signal to a facsimile machine.

Some embodiments of the method include creating an electronic record of the communication and optionally storing the electronic record in a memory storage device. The record can be a simple record that the transmission occurred or can be a copy of the transmission. Simply storing a record that the transmission occurred might be desirable in those instances where the transmission contained sensitive data, such as patient health information, age, sex, race, etc. The record can be stored either in a secure storage device inside a treatment facility (e.g., a hospital) or in a central storage location outside the hospital. If the system merely stores a record that the transmission occurred (without an actual copy of the transmission itself), then the system can assign a unique identification number that can be correlated back to a copy of the transmitted message stored in a secure storage device. Creation of the electronic record can be implemented from either the user terminal, the device that corresponds to the communication's destination or can be implemented automatically.

The user, transmitting the message can, in some instances, assign a priority level to the communication prior to the transmitting. If such a priority is assigned, the method includes informing the selected physician, upon receipt, of the assigned priority level.

If, for example, the selected physician's instructions indicate that a copy of a particular communication should be sent to a designated third-party recipient, the method can include sending the electronic communication to the designated third-party recipient.

Typically, the communication channel is a secure communication channel.

In another aspect, another method is disclosed for contacting a physician and communicating data to the physician. That method includes storing electronic data identifying physicians and contacting instructions associated with each identified physician, enabling each identified physician to customize at least some of the individualized contacting instructions that correspond to them, enabling a user to select one of the identified physicians to contact, where the applicability of at least one of the selected physician's contacting instructions depends on a condition precedent, electronically reviewing characteristics associated with the communication to determine whether the condition precedent is satisfied and transmitting an electronic communication from the user terminal over a communication channel in accordance with applicable contacting instructions associated with the selected physician.

In some implementations one or more of the following advantages may be present.

Physicians can be more easily contacted by medical personnel regardless of the physician's location. Patient-related and other data can be communicated to appropriate medical personnel in a timely manner and in a manner that is appropriate for the importance of the particular data being communicated. Additionally, attending physicians can create and customize instructions according to their own preferences and practices for how to contact and send data to them. Such instructions might be based on a number of criteria, including the content of the data, the time of day, the physician's physical location and other criteria. The amount of time that a staff member (e.g., a floor nurse) needs to spend figuring out how to contact and send data to appropriate parties can be reduced dramatically. Also, the amount of time that staff member needs to spend confirming that the data has been sent to everyone who needs to see it can be drastically reduced. Documentation of data transmission is simplified. Furthermore, important hospital staff members can spend less time and effort simply shuffling data around and more time focusing on the immediate needs of the patients under their care. Accordingly, the techniques disclosed herein might reduce overhead costs associated with providing medical care. Additionally, the data being sent to a particular device can be automatically formatted according to the intended destination device. Automatic formatting can include, for example, changing data from one file format to another so as to ensure that the transmitted data can be most easily viewed at the destination device. If, for example, the intended destination device is a Treo®, then the system can be adapted to recognize that the intended destination device is a Treo® and to automatically convert the data, if desirable, into a file format that is best suited for presentation on the Treo®. Alternatively, if the destination device is a BlackBerry®, the system can be adapted to recognize that the destination device is a BlackBerry® and to convert the data, if desirable, into a file format that is best suited for presentation at the BlackBerry®.

Other features and advantages will be readily apparent from the following detailed description, the accompanying drawings and the claims.

### BRIEF DESCRIPTION OF THE DRAWINGS

FIG. 1 is a network diagram of an embodiment of a system of the invention.

FIG. 2 illustrates an embodiment of a physician contact manager.

FIG. 3 is a flowchart of a method for facilitating contact with a physician and to communicate with the physician.

FIG. 4 is an exemplary screenshot of information presented to a user attempting to contact a physician according to the invention.

FIG. 5 is a flowchart of a method showing a physician's interaction with a system according to the invention.

FIG. 6 is an exemplary screenshot of a summary page showing modifiable information related to contacting a physician.

FIG. 7 is a network diagram of an alternative embodiment of a system according to the invention.

Like reference numerals refer to like elements.

### DETAILED DESCRIPTION

This application generally relates to a method for contacting a physician and a system for implementing that method. In some implementations, the method enables a user (e.g., a nurse, laboratory technician, another physician, etc.) to contact a particular physician in a timely, cost effective and efficient manner and in accordance with instructions from that particular physician. The method also enables physicians to manage how various parties contact them and to specify how various data should be communicated to them and to other designated parties.

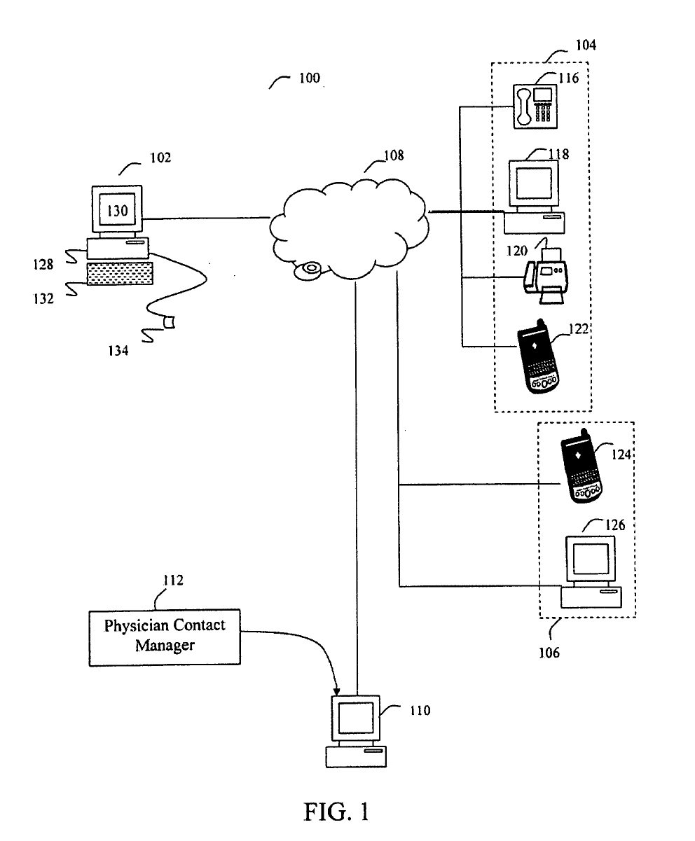

FIG. 1 is a network diagram of an embodiment of a system implementing the invention. The illustrated computer system 100 includes a user terminal 102, a first group 104 of communication devices and a second group 106 of communication devices. The first group 104 of communication devices is associated with a first physician and the second group 106 of communication devices is associated with a second physician. Typically, the user terminal 102 is a computer in a hospital or in a doctor's office. The user terminal 102 is coupled to the first 104 and second 106 groups of communication devices for communication therewith over a network 108. The illustrated user terminal 102 includes a computer 128 with a screen 130, a keyboard 132 and a mouse 134.

The first group 104 of communication devices includes a telephone 116 (e.g., a Voice over IP capable telephone), a computer 118, a facsimile machine 120 and a mobile e-mail device 122. The first physician can use any of those communication devices to send or receive electronic data. The second group 106 of communication devices includes a mobile e-mail device 124 and a computer 126. The second physician can use any of those communication devices to send or receive electronic data. The second physician can be a physician who periodically covers for the first physician.

A server 110 also is coupled to the network 108. The server 110 includes a physician contact manager 112. Generally, the physician contact manager 112 enables users (from user terminal 102) to contact physicians (e.g., the first physician and/or the second physician) in a timely, cost effective and efficient manner, in accordance with each physician's individualized instructions and in view of the communication being sent, the user's identity and input from the user regarding the urgency of the communication. The physician contact manager 112 also enables the physicians (and others) to create and modify instructions for contacting the physicians.

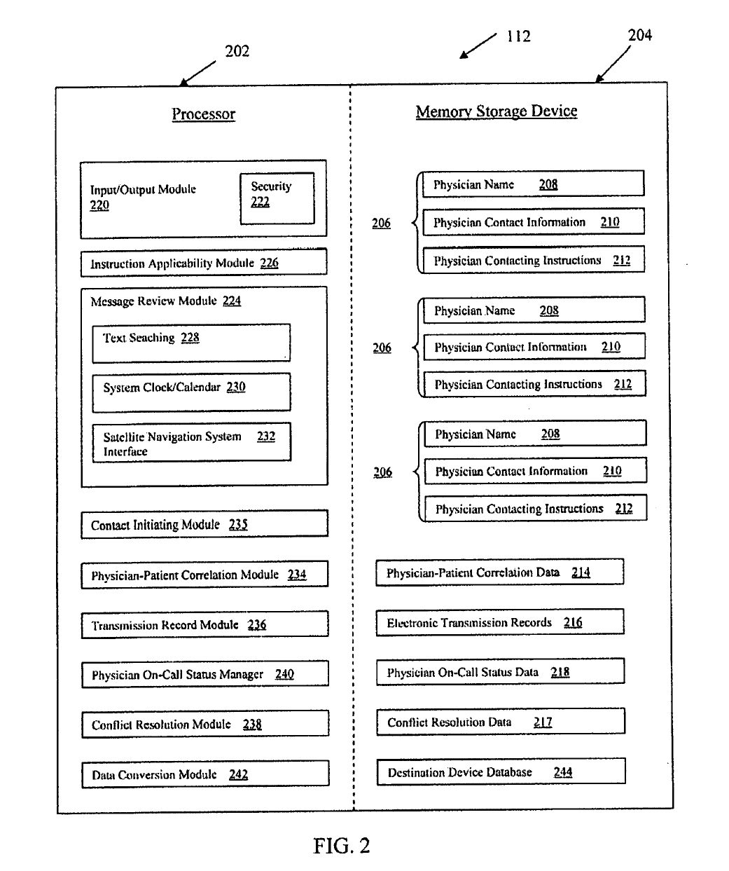

FIG. 2 illustrates an embodiment of a physician contact manager 112. The illustrated physician contact manager 112 includes a processor 202 and a memory storage device 204.

The memory storage device 204 includes a number of data groupings 206, each of which is adapted to store information related to a particular physician. Each data grouping 206 includes a physician's name field 208, a physician's contact information field 210 and a physician's contacting instructions field 212. Each physician name field 208 stores a name or a corresponding physician. Each physician contact field 210 stores contact information associated with the corresponding physician. Exemplary contact information includes home phone numbers, office phone numbers, secondary office phone numbers, cell phone numbers, secondary cell phone numbers, personal digital assistant contact information, SMS messaging contact information, electronic pager information, e-mail addresses, push e-mail addresses, BlackBerry® e-mail addresses, pocket personal computing device contact information, mailing addresses, facsimile machine numbers, etc. Other contact information can include coverage information for particular patients. Each physician contact instruction field 212 stores instructions from each corresponding physician for contacting them and/or their designees and for communicating various types of data to them and/or their designees. Exemplary contacting instructions include where to send critical information, where to send particular types of test results, who to contact with respect to particular types of questions, when to call the physician's office, when to call the physician's home, etc.

The memory storage device 204 also includes physician-patient correlation data 214. The physician-patient correlation data 214 includes, for example, a listing of each patient in a hospital and each patient's attending physician. Additionally, the memory storage device 204 stores electronic transmission records 216 that include electronic records documenting the transfer of various electronic messages across the network. The memory storage device 204 also stores physician on-call status data 218. That data 218 indicates whether particular physicians are on-call or not (i.e., whether they are available for consultation). The physician on-call status data 218 can indicate, for example, that a particular physician is available for certain kinds of consultation, but not for other kinds of consultation.

The memory storage device 204 also stores conflict resolution data 217 that can be referenced to help resolve conflicts between otherwise conflicting instructions. The stored conflict resolution data 217 typically define a hierarchy of instruction types.

The memory storage device 204 also includes a destination device database 244. The destination device database 244 stores data about various destination devices that can be used in the system. Such information can include capabilities and limitations of different devices, file formats that the different devices are best suited to handle, model numbers, etc.

The processor 202 includes an input/output module 220 that is adapted to receive and send electronic messages to and from a variety of external components. The illustrated input/output module 220 includes a security module 222 that helps ensure that those communications are performed in a secure manner.

The input/output module 220 also assists in managing communications between the physician contact manager 112 and external devices. For example, the input/output module 220 manages interactions from physicians accessing the physician contact manager 112 from external devices (e.g., computers). More particularly, the input/output module 220 enables those physicians to create, modify or delete contact information and/or contacting instructions stored in the memory storage device 204. Similarly, the input/output module 220 manages exchanges between users (e.g., physicians, nurses, laboratory technicians, etc.) that are attempting to contact a physician.

The input/output module 220 also is adapted to track whether particular destination devices are available for communication. A particular destination device might become unavailable for communication if it is turned off, if it loses battery charge or if it moves outside a coverage area. If data is directed to a particular destination device and the input/output module determines that the particular destination device is unavailable for communication, then the input/output module can inform the sender of the data and/or transmit the data to a secondary destination based on an algorithm that, optionally, may have been specified by the intended recipient of the data.

The processor 202 also includes a message review module 224 and an instruction applicability module 226 that work together to determine which physician contacting instructions apply to a particular electronic message. More particularly, the message review module 224 is adapted to electronically review incoming electronic messages. Toward that end, the message review module 224 includes text searching capabilities 228, a system clock/calendar 230 and a satellite navigation system interface 232.

The processor 202 also includes an instruction applicability module 226. The instruction applicability module 226 is adapted to determine which of the instructions specified by a particular physician should be applied to route a particular electronic message to that physician. The message review module 224 assists the instruction applicability module 226 in that task. More particularly, the message review module 224 reviews and analyzes features of the communication (e.g., content, the message's originator, time of transmission, location of the intended recipients, etc.) to help the instruction applicability module 226 determine which of the physician instructions are applicable to a given message. Toward that end, the message review module 224 includes text searching capabilities 228, a system clock/calendar 230 and a satellite navigation system interface 232. The text searching capabilities 228 enable the message review module to review electronic messages for keywords or phrases. In some implementations, the text searching capabilities 228 include voice recognition capabilities to facilitate reviewing voice messages for keywords. In some implementations, the text searching capabilities 228 include software, such as optical character recognition software, that is designed to translate images of handwritten or typewritten text (usually captured by a scanner) into machine-editable and machine-searchable text.

The system clock/calendar 230 is adapted to identify the time of transmission for each message. Since the applicability of some of the physician contacting instructions might depend on when the message is being transmitted, the applicability of those instructions depends on the date and time of message transmission. Accordingly, the message review module can reference the system clock/calendar to identify the time and date that a transmission is being sent. Based on that information, the instruction applicability module can determine whether a time/date dependent instruction should be applied.

The satellite navigation system interface 232 interacts with external satellites and tracking devices to track the locations of various physicians that use the system. The applicability of some of the physician contacting instructions might depend on the physician's location (e.g., in the office or at home). For example, a particular instruction might require placing a phone call to the physician's office when the physician is at his or her office, but sending an e-mail that can be accessed via a mobile device when the physician is away from his or her office. In that case, the message review module 224 obtains information about the physician's location from the satellite navigation system interface 232 and the instruction applicability module 226 determines whether to place a phone call to the physician's office or to send an e-mail to the physician's mobile e-mail device based on the physician's location information.

The processor 202 also includes a physician-patient correlation module 234. The physician-patient correlation module 234 is adapted to work with the message review module 224 to identify attending physicians assigned to patients. If, for example, a particular electronic communication is transmitted without designating an intended recipient, the message review module 224 can review the message for patient names. Once a patient name is found, the physician-patient correlation module 234 searches the physician-patient correlation data stored in the memory storage device 204 for the patient's name. If found, the physician-patient correlation data will indicate the patient's attending physician. Then, the physician-patient correlation module 234 can inform the instruction applicability module 226 to apply applicable contacting instructions for the identified attending physician and/or their coverage.

The processor 202 also includes a contact initiating module 235 that is adapted to establish and/or manage communications channels between the user terminal 102 and the other communication devices illustrated in FIG. 1. The communications channel module helps to establish communications channels that are appropriate for contacting each physician in accordance with the instructions that related to that physician.

The processor 202 also includes a transmission record module 236. The transmission record module 236 is adapted to create records of electronic communications and store those records as an electronic transmission record 216 in the memory storage device 204. The transmission record module 236 also is adapted to enable a user and/or a physician to create and store such records. In some implementations, the transmission record module prompts the user and/or physician to create such documents. The transmission record module 236 also is adapted to present electronic transmission records 216 to external devices for review by physicians and other users.

The computer system 100 can be adapted to accommodate a variety of different types of physician contacting instructions 212. For example, one such instruction might indicate which of the responsible physician's communication devices (e.g., from the first group 104 of communication devices) a particular type of patient-related data should be sent to. Another exemplary instruction might be to automatically send certain types of patient-related data to both the responsible physician and to another individual.

Physician contacting instructions 212 might be absolute or conditional. An example of a conditional instruction is to send patient-related data to a physician's e-mail account (accessible through computer 118 or mobile e-mail device 122) during the workday, but after hours to send such data to the responsible physician's home facsimile machine 120. Another example of a physician contact instruction 212 might simply be to call the physician.

In some implementations, some of the contacting instructions 212 in memory storage device 204 are modifiable by individual physicians while other contacting instructions 212 are not. Typically, the non-modifiable instructions would be those set by a system administrator. There may be a variety of reasons for not allowing a physician to modify particular contacting instructions. As an example, non-modifiable instructions might relate to communication policies set by a hospital, for example, in hospital by-laws. If, for example, a hospital implemented a communication policy that required all patient-related data to be sent at least via facsimile to the attending physician, then a hospital administrator might access the electronic database, enter that instruction for all physicians and indicate that that instruction cannot be overridden by an individual physician. If the hospital administrator took those steps, then no physician would be able to override that instruction in the memory storage device 204. However, individual physicians would be able to add additional instructions as long as those additional instructions did not conflict with the instruction set by the hospital administrator. Other laws might exist that require particular actions to be taken in a particular manner.

The processor 202 also includes a conflict resolution module 238 that helps to resolve conflicts that might arise between different physician contacting instructions 212. Typically, such conflicts are resolved based on a hierarchy of instruction types. Accordingly, certain types of instructions (e.g., those set by a system administrator) typically override other types of instructions (e.g., those set by a physician) that conflict therewith. Conflict resolution techniques can vary considerably based on the needs of those using the computer system 100. The conflict resolution module 238 references the conflict resolution data 217 stored in memory storage device 204.

The processor 202 also includes a physician on-call status manager 240. The physician on-call status manager 240 manages storing and accessing physician on-call status data (and coverage data) 218 in the memory storage device 204.

The processor also includes a data conversion module 242. The data conversion module 242 is adapted to recognize the destination device and, if desirable, automatically format the data being transmitted according to the capabilities of the intended destination device. Automatic formatting can include, for example, changing data from one file format to another so as to ensure that the transmitted data can be most easily viewed at the destination device. If, for example, the intended destination device is a Treo®, then the data conversion module is adapted to recognize that the intended destination device is a Treo®. The data conversion module 242 then references the destination device database 244 to determine, for example, the preferred file format for data being sent to a Treo®. Based on the referenced information, if desirable, the data conversion module 242 automatically converts the data into a file format that is best suited for presentation on the Treo®. Alternatively, if the data conversion module 242 identifies the destination device as a BlackBerry®, then the data conversion module 242 references the destination device database 244 for BlackBerry® information and, if desirable, converts the data into a file format that is best suited for presentation at the BlackBerry®.

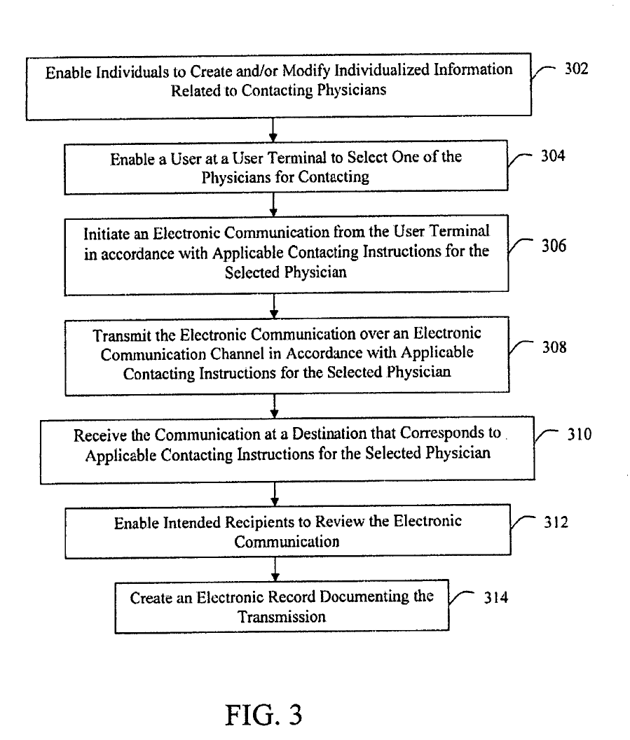

FIG. 3 is a flowchart of a method of contacting a physician and communicating, for example, patient-related data from a user terminal to the physician. The illustrated method facilitates the communication of such data in accordance with the individualized instructions associated with each physician. The illustrated method can be implemented, for example, on the computer system 100 of FIGS. 1 and 2.

The illustrated method includes enabling 302 individuals (e.g., physicians) to create and/or modify information that relates to contacting each of the physicians. The information created and/or modified is stored in the data groupings 206 of memory storage device 204. Typically, each physician is able to create and/or modify information that relates to him or herself. In some implementations, other personnel including, for example, hospital administrators have the ability to create and/or modify certain types of information related to contacting the physicians.

Typically, the information related to contacting the physicians includes the physicians' names, contact information for each of the physicians and instructions for how to contact each of the physicians. The contact information for each physician can include, for example, home phone numbers, office phone numbers, secondary office phone numbers, cell phone numbers, secondary cell phone numbers, personal digital assistant contact information, SMS messaging contact information, electronic pager information, e-mail addresses, push e-mail addresses, BlackBerry® e-mail addresses, pocket personal computing device contact information, mailing addresses, facsimile machine numbers, etc. for each physician. The instructions for how to contact each physician can differ from physician to physician. Some of the instructions are absolute and applicable, therefore, to every contact made with a physician. Other instructions can be conditional, and depend, for example, on when contact is being established, what type of information the contactor is attempting to send to the physician, the physician's physical location, and/or the importance of the information that the contactor wants to send to the physician.

Typically, in order to create and/or modify information relating to contacting a physician, the individual logs onto a password-secured website from a computer (e.g., user terminal 102, computer 118 or computer 126). Typically, the security module 222 of the input/output module 220 requires that the individual enter a password to access data in the memory storage device 204. The security module 222 also restricts the individual's access to create and/or modify instructions that relate to only certain of the physicians. For example, in some implementations, the security module 222 prevents a physician from creating and/or modifying instructions that pertain to contacting any other physicians. Group security rules can be implemented that apply to entire groups of system users.

The security module 222 also typically ensures that communications between the physician contact manager 112 and external components are conducted in a secure manner. A variety of techniques may be utilized to ensure an appropriate level of security. Such techniques include, for example, data encryption. The need to implement heightened security measures can be particularly significant when interactions or data communications relate, for example, to a patient's health, sex, race, age, etc.

The illustrated method also includes enabling 304 a user at user terminal 102 to select one of the physicians, whose contacting information has been stored in the memory storage device 204, for contacting.

Typically, the user logs onto a password-secured website from the user terminal 102. Typically, the security module 222 of the input/output module 220 requires that the user enter a password to access the physician names 208 stored in the memory storage device 204. The security module 222 also restricts the users access to only those functions associated with contacting physicians. A user accessing the physician contact manager 112 to contact a physician typically would not have access to create and/or modify instructions for contacting any of the physicians.

Once the user enters an appropriate password, the input/output module 220 typically presents the user with a list that includes at least the names of the physicians who have created contacting instructions. The list of physician names is created from the physician names 208 stored in the memory storage device 204. The list is presented at the user terminal 102.

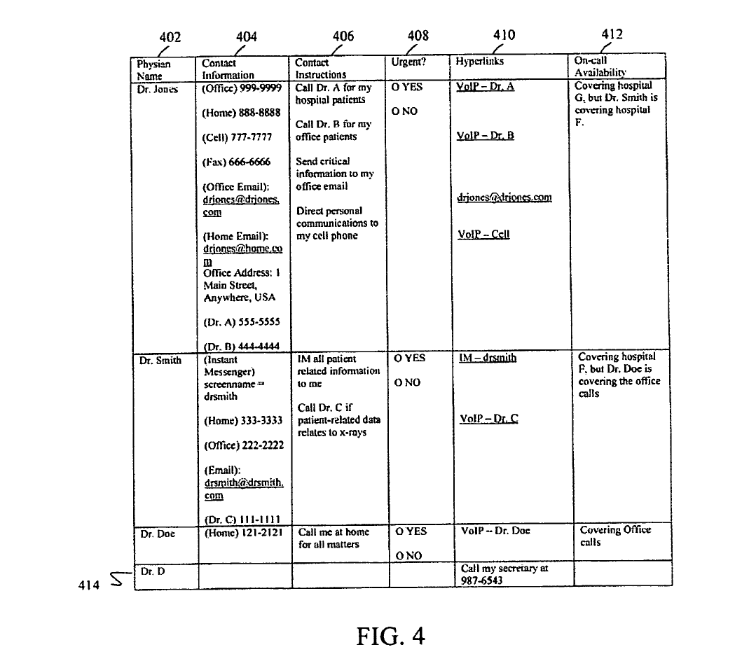

In some implementations, the list of physician names can be presented to the user along with other information as well. For example, the list may be one column of a table (see FIG. 4) that includes other information as well. Indeed, the table illustrated in FIG. 4 includes several columns. The first column 402 includes a list of physician names. In some implementations, each physician name is a hyperlink, the selection of which causes the physician contact manager 112 to initiate communication from the user terminal 102 in accordance with applicable contacting instructions for the selected physician. So if, for example, a selected physician had instructed that all contact be made by e-mail to an account that the selected physician can access via a mobile communication device, then selecting that physician's name might open an e-mail directed to that e-mail address. If, as another example, a different physician had instructed that all contact be made by phone to his or her office, then selecting that physician's name might establish a voice over internet protocol (VoIP) communication channel from the user terminal 102 to the physician's office phone number.

The second column 404 in FIG. 4 includes contact information identifying a number of ways of contacting each physician. The third column 406 includes contacting instructions. Some of the contacting instructions might have been physician-specified and some of the contacting instructions might have been specified by other individuals (e.g., hospital administrators). The fourth column 408 provides a user with the opportunity to optionally assign an urgency level to the communication. If, for example, a particular communication to Dr. Jones is urgent, the user might select the circle next to “Yes” under the column marked “Urgent?” for Dr. Jones.

The fifth column 410 includes hyperlinks, the selection of which activates particular communication methods that correspond to the selected physician's contacting instructions from the third column 406. As an example, the first hyperlink “VoIP—Dr. A” in the hyperlink column 410 corresponds to the contact instruction in column 406, “Call Dr. A for my hospital patients.” Selection of that hyperlink activates a voice over internet protocol (VoIP) connection through the network to Dr. A's phone number. The VoIP connection enables the routing of voice conversations over the network. The user would then be enabled to transmit a voice message to Dr. A's phone.

The sixth column 412 indicates each physician's on-call status. The user might use that information to determine how to best convey different information. Each physician is typically able to create and/or modify his or her own on-call availability. In the illustrated example, Dr. Jones has apparently indicated that he is covering hospital G, but Dr. Smith is covering hospital F. Additionally, Dr. Smith has indicated that he is covering hospital F, but Dr. Doe is covering office calls. Dr. Doe has indicated that he is covering office calls.

In some implementations, if the user does not know the name of the physician to be contacted, but has information regarding a particular patient, the input/output module 220 prompts the user to enter the patient's name at the user terminal 102. Based on the information provided by the user, the physician-patient correlation module 234 references the physician-patient correlation data 214 in memory storage device 204 to correlate the patient's name to a physician assigned to be that patient's attending physician.

The bottom row 414 of the illustrated table shows instructions that were provided by Dr. D to simply call his/her secretary at,a particular number. A user seeing those instructions might decide to simply pick up a phone and make that call.

Returning to the method illustrated in FIG. 3, once the physician to be contacted is identified, the contact initiating module 235 initiates 306 an electronic communication from the user terminal 102 in accordance with applicable contacting instructions for the selected physician. In some implementations, the contact initiating module 235 initiates the electronic communication automatically in response to the user's selection of a physician to contact. If, for example, a user selects a particular physician and that physician has instructed that he or she should be contacted via a phone call to a personal cell phone number, in response to the user's selection, the contact initiating module 235 automatically establishes a VoIP connection from the user terminal 102 to the selected physician's cell phone. As another example, if the selected physician has instructed that he or she be contacted through e-mail, then, in response to the user's selection, the contact initiating module 235 might automatically create an e-mail directed to the selected physician.

In some instances, the contact initiating module 235 does not initiate an electronic communication channel automatically in response to the user's selection of a physician to be contacted. If, for example, a particular instruction includes a condition precedent, then, before initiating communications, the physician contact manager 112 would need to determine whether that condition precedent has been satisfied. As an example, an instruction to send patient-related data that relates to a particular patient (e.g., Jane Doe) to a destination that is different than the destination for all other data has a condition precedent that the data to be sent relates to Jane Doe. That is, the instruction only applies to data that relates to Jane Doe. Generally, conditions precedent can relate to the text of the intended communication (e.g., if the text mentions “x-ray”), the time and/or date of transmission (e.g., if the transmission is occurring during normal working hours), the intended recipient's physical location (e.g., if the physician that is being contacted is in his or her office or not), etc. There are a number of ways that the physician contact manager 112 can determine whether a particular condition precedent has been satisfied and that, therefore, instructions that require that condition precedent be applied.

One way that the physician contact manager 112 can determine whether a particular condition precedent has been satisfied is for the input/output module 220 to query the user about that condition at user terminal 102. For example, in the example above, the user might be prompted to indicate whether an intended communication to the selected physician was related to Jane Doe. If the user responds affirmatively, then the contact initiating module 235 would automatically initiate an e-mail directed to the e-mail account that the selected physician could access via the mobile communication device. If, on the other hand, the user responds in the negative, then the contact initiating module 235 would automatically initiate a communication channel from the user terminal 102 to the selected physician's facsimile machine.

Another way that the physician contact manager 112 can determine if a particular condition precedent has been satisfied is by reviewing relevant characteristics associated with the communication. Those characteristics can include, for example, the text of the intended communication, the time and/or date of transmission, the intended recipient's physical location, etc.

In order to review the characteristics related to the text of a communication, the input/output module 220 prompts the user, through user terminal 102 to enter the text of the communication. A variety of methods are available to enter the text of the message. Those methods include, for example, typing the text, scanning the text, reciting the text into a microphone at the user terminal, etc. Once the user has entered the text, the message review module 224 uses its text searching capabilities 228 to review the text for keywords that are relevant to the condition precedent under consideration. If those keywords are found, then the instruction applicability module 226 identifies the instruction related to that condition precedent as being applicable. If the user scans the text using a scanner coupled to the user terminal, then the message review module 224 utilizes optical character recognition techniques to facilitate its search of the text. If the user recites the text into a microphone at the user terminal 102, then the message review module 224 implements voice recognition software to transform the spoken word into text-searchable data.

In order to review the time and/or date of the transmission, the message review module 224 references its system clock/calendar 230. Based on the referenced time and/or date, the instruction applicability module 226 determines the applicability of the instruction that relates to the time/date condition precedent.

In order to review the intended recipient's physical location, the message review module 224 references the satellite navigation system interface 232 to determine the location of the intended recipient. Based on that information, the instruction applicability module 226 determines the applicability of the instruction that relates to the intended recipient's physical location.

Next, the illustrated method includes transmitting 310 the electronic communication over an electronic communication channel from the user terminal 102 in accordance with the applicable contacting instructions for the selected physician. Typically, that step includes sending the communication to the responsible physician. However, that step also can include sending data to other individuals as well. Whether data is sent to other individuals (e.g., covering physicians, physician extenders, or house staff members) usually depends on whether the selected physician or other authorized, instruction-creating individual has designated other parties to receive such information. In some implementations, transmitting begins automatically in response to the user selecting one of the physicians to contact.

Typically, the communication is transmitted in a manner that is dependent on the responsible physician's preferred method for being contacted. As an example, if the applicable instructions mandate that all patient-related data be sent via e-mail, then the system would transmit an e-mail that included the patient-related data either in the text of the e-mail or as an attachment to the e-mail. Alternatively, if the applicable instructions indicate that a particular communication be transmitted to a cell phone, then a VoIP connection would be established from the user terminal to the cell phone and the communication would be transmitted by voice over that VoIP connection.

After traveling through the network 108, the one or more electronic messages are received 312 at one or more destinations. The one or more destinations correspond to the selected physician's instructions. Exemplary destinations include communication devices associated with the selected physician and/or communication devices associated with the selected physician's designated recipients.

The illustrated method includes enabling 314 the intended recipient(s) (e.g., the responsible physician and/or any other designated recipient) to review the electronic communication. Generally, the recipient(s) accomplish that by accessing one of the electronic messages through an appropriate one of the communication devices associated with that recipient and to which the one or more electronic messages was directed.

Next, the illustrated method includes creating 316 a record of the data transmission. That record can be an electronic document indicating, for example, the type of patient-related data that was transmitted, the delivery status of that transmitted data (e.g., “data sent”, “data received”, “data reviewed”, etc.), the date and time of the transmittal and/or receipt, any comments about the transmittal entered by either the sender or the receiver, etc. In some implementations, the record can be a simple record that indicates a transmission has occurred or can be a copy of the transmission. Simply storing a record that the transmission occurred might be desirable in those instances where the transmission contained sensitive data, such as patient health information, age, sex, race, etc. The record can be stored either in a secure storage device inside a treatment facility (e.g., a hospital) or in a central storage location outside the hospital. If the system merely stores a record that the transmission occurred (without an actual copy of the transmission itself) , then the system can assign a unique identification number that can be correlated back to a copy of the transmitted message stored in a secure storage device. The record can be created automatically or in response to prompting from either the sender of the communication or the recipient of the communication. In some implementations, that record is stored in memory storage device 204. The data transmission record also could reflect individuals other than the responsible physician who received the communication and information about the status of delivery to those individuals.

In some implementations, the data transmission record is created automatically upon transmission of the communication to the responsible physician. Subsequently, the data transmission record is automatically updated when, for example, an intended recipient receives and/or reviews the communication. In some implementations, either the user who sent the communication or the recipient(s) of the communication can create and/or modify the data transmission record.

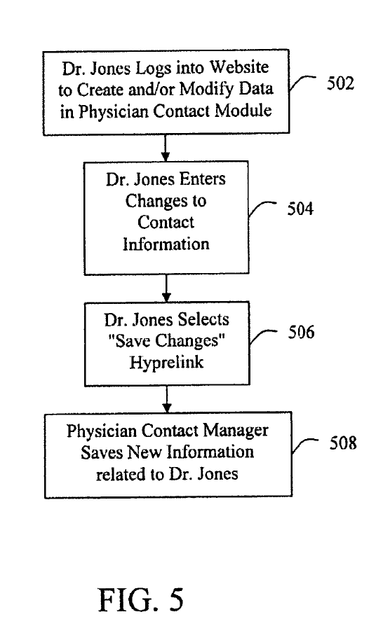

FIG. 5 is a flowchart of a method showing a physician's (e.g., Dr. Jones) interaction using the computer system 100 of FIG. 1 to create and to modify information regarding contacting Dr. Jones.

According to the illustrated method, Dr. Jones uses computer 118 to log 502 into a website to access the data stored in the physician contact module 112.

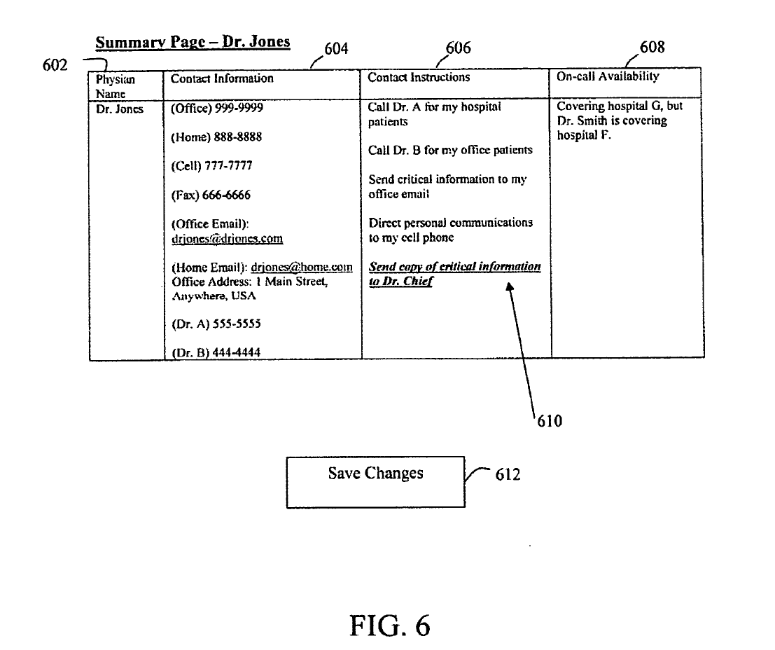

Once Dr. Jones is successfully logged onto the website, the physician contact module 112 presents a summary page (see, e.g., FIG. 6) showing information associated with that Dr. Jones. In the illustrated implementation, the summary information is presented in a table format. The first column 602 of the table identifies the physician's name (i.e., Dr. Jones). The second column 604 of the table includes Dr. Jones' contact information. The third column 606 of the table includes Dr. Jones' contact instructions. The fourth column 608 of the table includes Dr. Jones' on-call availability.

Most of the information shown in the illustrated summary page is modifiable by Dr. Jones. The only information that is not modifiable by Dr. Jones in the illustrated table is his name “Dr. Jones” and one of the contact instructions 610 reads “send copy of critical information to Dr. Chief.” That instruction is indicated in a different font than the other instructions, because that instruction is not modifiable by Dr. Jones.

A “save changes” hyperlink 612 is provided at the bottom of the screen. Selection of that hyperlink calls up a new screen that includes all of the information shown in FIG. 6, but in a modifiable form (except for the one contact instruction 610 that is not modifiable by Dr. Jones).

Referring again to the method of FIG. 5, after logging into the website and being presented with the screen of FIG. 6, Dr. Jones enters 504 changes to some of the contact information indicated in the table.

Subsequently, Dr. Jones selects 506 the “save changes” hyperlink. Selecting that hyperlink causes the physician contact manager 112 to update 508 the data in the memory storage device 204 in accordance with the changes entered by Dr. Jones.

In some implementations, the summary page of FIG. 6 would also reflect a list of patients, for which Dr. Jones is the attending physician.

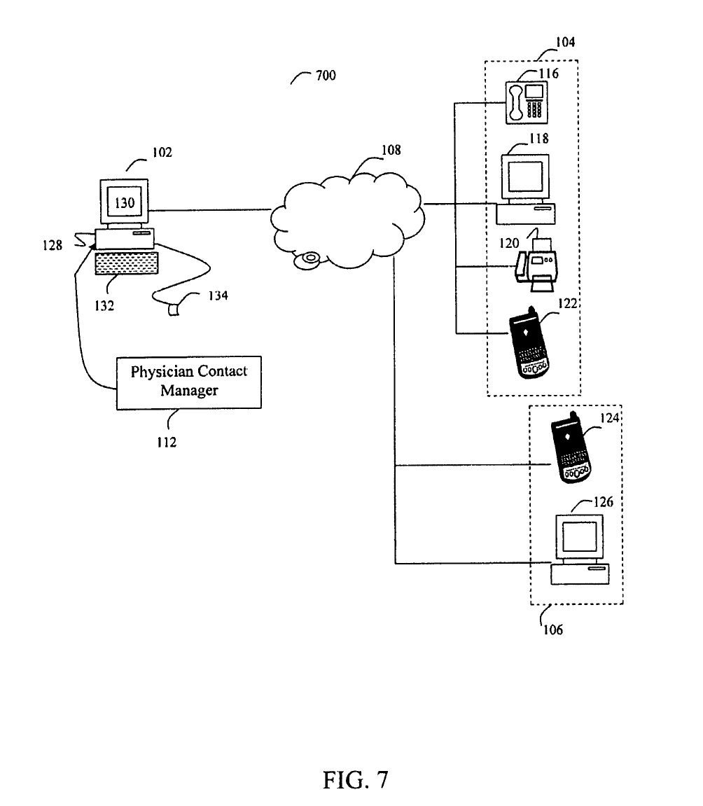

FIG. 7 is a network diagram of an alternative embodiment of a system according to an implementation of the invention.

The system 700 of FIG. 7 is identical to the system 100 shown in FIG. 1 except that the physician contact manager in FIG. 7 resides in the user terminal 102.

It should be understood that in other implementations the physician contact module could reside in any number of places in the illustrated computer system 700.

A number of implementations have been described. Nevertheless, it should be understood that various modifications and applications of the concepts described herein may be made without departing from the spirit and scope of the invention. For example, the user terminal 102 could be any type of electronic device that enables a user to communicate electronic data over a network. Such devices include, for example, a landline-based telephone, a cellular telephone, a facsimile machine, or any other device that is suitable for communicating electronic data.

In implementations where the user terminal 102 is a telephone, then the computer system 100 might include voice recognition capabilities in order to facilitate review of the patient-related data for keywords, etc. Voice recognition capabilities can be implemented either through hardware, software or a combination of both. Alternatively, in implementations where the user terminal 102 is a facsimile machine, the computer system 100 might include optical character recognition (OCR) capabilities in order to facilitate the review of patient-related data stored as a scanned image by the facsimile machine. OCR capabilities also can be implemented through hardware, software or a combination thereof.

The user terminal 102 can include any type of data input means. For example, in some implementations, the user terminal 102 includes an electronic pen adapted to create electronic images based on motion of the pen. An example of such a pen is the io™2 digital pen, available from Logitech®.

Other technology can be implemented to track the location of a physician, such as LoJack®-type systems, systems that determine location based on the access point in a wireless local area network (e.g., wi-fi) that a mobile device uses, etc.

The network 108 can be a local area network, a wide area network or the internet. The communication devices shown in FIG. 1 can be connected to each other in a variety of different ways. Additionally, the communication devices can be located at different physical locations (e.g., hospitals, physician's offices, physician's homes, etc.).

Additionally, data and information can be stored in multiple different memory storage devices distributed across the computer system 100. Similarly, a variety of different processors can be used to implement the techniques disclosed herein.

In some implementations, a physician can use the system to specify a contact method that cannot be automatically accessed through the user terminal. In those implementations, the user at the user terminal will be provided with appropriate instructions.

Certain implementations of the system can be staffed by an operator with authority to access the physician contact information and modify that information on behalf of particular physicians. In those instances, a physician might be able to call the operator from a remote location to update their contact information on a timely basis.

In some implementations, the system can be adapted to provide a read receipt or a delivery receipt to a user who originates a particular electronic communication. Indeed, depending on the type of destination device involved, it could be impossible to send a read receipt. For example, certain one-way beepers do not provide any indication of a read receipt to the sender. In those instances, the system could be adapted to provide a delivery receipt to the user. The input/output module could be adapted to perform that function.

The screenshots presented to physicians and other system users can vary in appearance. Also, the computer system can enable a user to navigate between screens to access the information and functionalities disclosed herein in a number of ways.

The particular order of steps disclosed in connection with the methods described herein can be varied. Moreover, in some implementations, certain of those steps can be eliminated entirely. For example, in certain implementations, the step associated with creating a record of the data transmission might be eliminated. Similarly, in certain implementations, reviewing features of the intended communication to determine applicability of certain instructions might not be necessary, either because all of the instructions for a particular physician are unconditional or for some other reason.

The system and techniques disclosed herein can be adapted for use with any number of physicians and can be used with multiple user terminals. Moreover, the system and techniques disclosed herein can be adapted to help manage the transmission of any type of data to people other than just physicians and medical personnel.

The rules that define the responsible physician's preferences can take a number of forms. Some, for example, might be dependent on the time of day that a particular communication is being sent. For example, the rule might request workday communications be faxed to the physician's office, while nighttime transfers be e-mailed to a personal e-mail address that is accessible from the physician's home computer. In those instances, the system includes an electronic clock that is referenced to determine the applicability of time-dependent rules to the transmission of particular communications.

Similarly some rules might be dependent on the responsible physician's physical location. Accordingly, the computer system 100 might be adapted to interact with a satellite tracking system to track the physical location of the various physicians that use the system. In systems having that capability, the physician might specify a contact rule that requires sending patient-related data to the physician's office when the physician is in his or her office, but sending patient-related data to an e-mail address that the physician has mobile access to if the physician is located away from his or her office. Many other rules and formats of rules may be possible.

The functionality of the physician contact module can be implemented either on a centralized server (e.g., server 110 of FIG. 1) or in a peer-to-peer manner. In general, a peer-to-peer network is one in which all computers are treated as equals on the network. Individual computers may share hard drives, CD-ROM drives, and other storage devices with the other computers on the network. In some implementations, the system is adapted to integrate and/or interface with a patient's electronic chart, at either a hospital and/or office/clinic. This could be done by hard coding into a vendors product or through the addition of either modules, “plug ins” or external links. A stand alone system with a web interface or a fat client might be adapted to run the specific application. Two-way interfaces back to existing systems may be created in real time or batch mode to create, verify or update relationships or personnel and to allow for a single set of security rules within an organization or group.

Various features of the system and techniques disclosed herein can be implemented in hardware, software or a combination of hardware and software. For example, some features of the system can be implemented in computer programs executing on programmable computers. Each program can be implemented in a high level procedural or object oriented programming language to communicate with a computer system. Furthermore, each such computer program can be stored on a storage medium, such as read-only memory (ROM) readable by a general or special purpose programmable computer or processor, for configuring and operating the computer when the storage medium is read by the computer to perform the functions described above.

Accordingly, other implementations are within the scope of the following claims.

What is claimed is:

1. A method of contacting a physician to electronically communicate with the physician, the method comprising:
storing electronic data identifying a plurality of physicians and contacting instructions associated with each identified physician;
enabling a user to select one of the identified physicians to contact; and
in response to the user's selection, transmitting an electronic communication from the user terminal over a communication channel in accordance with the contacting instructions associated with the selected physician.

2. The method of claim 1 further comprising enabling each identified physician to customize at least some of the individualized contacting instructions that correspond to them.

3. The method of claim 1 wherein applicability of at least one of the selected physician's instructions depends on a condition precedent, the method further comprising:
electronically reviewing characteristics associated with the communication to determine whether the condition precedent is satisfied.

4. The method of claim 1 further comprising:
identifying a destination device for the electronic communication,
wherein transmitting the electronic communication comprises providing data in the electronic communication in a format well-suited for presentation at the destination device.

5. The method of claim 4 further comprising converting the data from a first file format to a second file format.

6. The method of claim 3 wherein electronically reviewing the characteristics associated with the communication comprises electronically searching the communication for keywords that relate to the condition precedent.

7. The method of claim 3 wherein electronically reviewing the characteristics associated with the communication comprises referencing an electronic clock/calendar to determine whether the communication is being transmitted at a time relevant to the condition precedent.

8. The method of claim 3 wherein electronically reviewing the characteristics associated with the communication comprises utilizing an electronic tracking system to identify the selected physician's physical location when the communication is being transmitted.

9. The method of claim 1 further comprising presenting a list of the identified physicians to a user at a user terminal.

10. The method of claim 9 wherein the list of physician names further comprises:
contact information associated with one or more ways of contacting each identified physician; and
each identified physician's contacting instructions.

11. The method of claim 9 wherein the list of physician names further comprises:
each identified physician's availability for being contacted.

12. The method of claim 9 wherein the list of physician names further comprises coverage information associated with each listed physician.

13. The method of claim 1 wherein enabling the user to select one of the identified physicians to contact comprises:
prompting the user to enter a patient's name at the user terminal; and
referencing an electronic database to correlate the patient's name to the selected physician's name.

14. The method of claim 1 wherein transmitting the electronic communication comprises sending the electronic communication over the communication channel to a destination that corresponds to the selected physician's contacting instructions.

15. The method of claim 14 further comprising:
receiving the electronic communication at the destination.

16. The method of claim 1 further comprising:
providing a delivery status of the electronic communication to the user.

17. The method of claim 1 further comprising:
determining whether a device that corresponds to the selected physician's contacting instructions is available for communication; and
rerouting the electronic communication depending on the determination.

18. The method of claim 1 wherein the electronic communication is selected from the group consisting of: e-mails, instant messages, voice signals, postings to an electronic bulletin board, personal digital assistant messages, SMS messages to a cell phone, electronic pages, push e-mail, signals to pocket personal computing devices and signals to facsimile machines.

19. The method of claim 1 further comprising:
creating an electronic record of the communication; and
storing the electronic record in a memory storage device.

20. The method of claim 19 further comprising prompting creation of the electronic record at the user terminal.

21. The method of claim 19 further comprising prompting creation of the electronic record at a device that corresponds to the communication's destination.

22. The method of claim 1 further comprising:
enabling the user to assign a priority level to the communication prior to the transmitting; and
informing the selected physician, upon receipt, of the assigned priority level.

23. The method of claim 1 wherein the selected physician's instructions indicate that a copy of a particular communication should be sent to a designated third-party recipient, and
wherein transmitting the electronic communication from the user terminal over the communication channel in accordance with the selected physician's contacting instructions comprises sending the electronic communication to the designated third-party recipient.

24. The method of claim 1 wherein the communication channel is a secure communication channel.

25. The method of claim 1 further comprising:
depending on a destination device for the electronic communication, providing either a read receipt or a delivery receipt to the user.

26. A method of contacting a physician and communicating data to the physician, the method comprising:
storing electronic data identifying a plurality of physicians and contacting instructions associated with each identified physician;
enabling each identified physician to customize at least some of the individualized contacting instructions that correspond to them;
enabling a user to select one of the identified physicians to contact, wherein applicability of at least one of the selected physician's contacting instructions depends on a condition precedent;
electronically reviewing characteristics associated with the communication to determine whether the condition precedent is satisfied; and
transmitting an electronic communication from the user terminal over a communication channel in accordance with applicable contacting instructions associated with the selected physician.

27. The method of claim 26 further comprising enabling a physician's designee to customize at least some of the individualized contacting instructions that correspond to the physician.
